(19) United States
(12) Patent Application Publication
(10) Pub. No.: US 2023/0401134 A1
(43) Pub. Date: Dec. 14, 2023

(54) SYSTEMS AND METHODS FOR ANALYZING PROCESS AND RESOURCE METRICS ACROSS CLIENT DEVICES

(71) Applicant: Citrix Systems, Inc., Fort Lauderdale, FL (US)

(72) Inventors: Rahul Gupta, Bengaluru (IN); Prabhjeet Singh Chawla, Bengaluru (IN)

(21) Appl. No.: 17/836,550

(22) Filed: Jun. 9, 2022

(51) Int. Cl. G06F 11/30; G06F 9/50; G06F 9/54

(52) U.S. Cl. CPC G06F 11/3006; G06F 11/3072; G06F 9/5027; G06F 9/542; G06F 2201/81

(57) ABSTRACT

Described embodiments provide systems and methods for analyzing process and resource metrics across client devices. A resource manager may receive metrics on resource utilization of a plurality of processes executing on at least some of a plurality of client devices. The resource manager may select a subset of the plurality of processes based on the metrics. The resource manager may determine a subset of the plurality of client devices which are executing the selected subset of processes. The resource manager may generate an alert which identifies the subset of processes and the subset of client devices which are executing the subset of processes.

### FIELD OF THE DISCLOSURE

The present application generally relates to resource utilization across client devices. In particular, the present application relates to systems and methods for analyzing process and resource metrics across client devices.

### BACKGROUND

A client or client device may execute various processes in operation. Some processes may contribute to greater resource utilization than other processes. As resource utilization increases, client device performance may correspondingly decrease, particularly where resource utilization approaches resource limits of the client device.

### BRIEF SUMMARY

This summary is provided to introduce a selection of concepts in a simplified form that are further described below in the Detailed Description. This summary is not intended to identify key features or essential features, nor is it intended to limit the scope of the claims included herewith.

During operation of a client device, the client device may execute various processes, such as applications, resources, background executables, etc. Each of the processes executing on the client may consume or utilize a certain amount of computing resources (such as central processing unit (CPU) resources, graphics processing unit (GPU) resources, memory, disk space, network throughput, power, etc.). Some analytics services may offer infrastructure analytics that show administrators different client devices and workload. Such infrastructure analytics may provide visibility into each client device's resource trend along with, for example, the top processes that are contributing to or causing a spike in resource consumption. Some infrastructure analytics may provide an option to perform actions on a particular client device. However, such infrastructure analytics may not work at scale for a virtualized environment where an enterprise has (for instance) thousands of client devices spanning across multiple delivery groups and sites.

According to the systems and methods of the present solution, a resource manager (e.g., executing on a server) may receive metrics on resource utilization of a plurality of processes executing on at least some of a plurality of client devices. The resource manager may select a subset of the processes based on the metrics (e.g., received from the client devices). The resource management server may determine a subset of client devices which are executing the selected processes, and generate an alert which identifies the subset of processes and subset of client devices.

In various embodiments of the present solution, the resource manager may receive metrics across all client devices of an enterprise, and identify the top processes (including durations in which those processes were executing) which are causing spikes in resource consumptions across sites and delivery groups and correspondingly causing poor user experiences to employees using those client devices. The resource manager may generate alerts (e.g., on user interfaces or notifications) for an administrator computing device. As such, an administrator computing device may render data corresponding to processes which occur consistently across the enterprise. Additionally, where processes are mandatory (such as mandatory security scans or tools), the administrator may change the schedule of those processes to the extent execution of such processes hinder day-to-day operation of the client devices. The resource manager may also maintain policies corresponding to black or white-listed processes, which may include malicious processes that are to be blocked and/or processes which are mandatory.

The resource manager may receive metrics on resource data and process data for each of the client devices. In some embodiments, the resource manager may receive the metrics directly from the client devices, or from another component or element that maintains such data (such as a traffic management service to which the client devices report such data). The resource manager may receive the data at different intervals (such as the resource data every five minutes, and process data every ten minutes, for example). With the combination of both the resource data and process data, the resource manager may identify the top processes (e.g., cross client devices) that are contributing to resource utilization. The resource manager may identify processes that cause or contribute to increased resource utilization across delivery groups and/or sites. The resource manager may categorize the processes into various categories/application types within the delivery group level that are contributing to higher usage for a certain percentage of users/client devices. The resource manager may generate alerts or notifications for an administrator computing device which processes are contributing to resource utilization, such that an administrator can determine whether there are any alternative processes that could be executed that reduce resource utilization. Additionally, the resource, process, and/or categorized data may be stored or maintained in one or more data structures or databases for root cause analysis (RCA).

Aspects of the present disclosure are directed to systems, methods, and non-transitory computer readable media for generating alerts relating to resource utilization of processes across client devices. A resource manager may receive metrics on resource utilization of a plurality of processes executing on at least some of a plurality of client devices. The resource manager may select a subset of the plurality of processes based on the metrics. The resource manager may determine a subset of the plurality of client devices which are executing the selected subset of processes. The resource manager may generate an alert which identifies the subset of processes and the subset of client devices which are executing the subset of processes.

In some embodiments, the resource manager may apply a filter to the plurality of processes based on a policy corresponding to at least some of the plurality of policies. In some embodiments, the alert may be a first alert. The resource manager may identify, from the plurality of processes, at least one process to be excluded from execution. The resource manager may determine which of the plurality of client devices are executing the at least one process. The resource manager may generate a second alert identifying the at least one process and which of the plurality of client devices are executing the at least one process. In some embodiments, the metrics may include, for each of the plurality of client devices, a duration in which a respective client device has resources exceeding a threshold, and a list of processes executing on the client device for the duration. In some embodiments, the duration is received at a first time interval, and the list of processes is received at a second time interval.

In some embodiments, the resource manager may categorize each of the plurality of processes into respective process categories. In some embodiments, the resource manager may filter from one or more processes executing on a respective client device, a first process from the one or more processes based on a duration in which the first process executed on the respective client device. In some embodiments, selecting the subset of the plurality of processes is based on the metrics and a number of the plurality of client devices which are executing the subset of the plurality of processes. In some embodiments, a process of the plurality of processes is selected based on a proportion of the number of the plurality of client devices which are executing the process relative to a total number of the plurality of clients. In some embodiments, the resource manager may store, in one or more data structures, the identified subset of processes and the subset of client devices which are executing the subset of processes.

### BRIEF DESCRIPTION OF THE DRAWING FIGURES

Objects, aspects, features, and advantages of embodiments disclosed herein will become more fully apparent from the following detailed description, the appended claims, and the accompanying drawing figures in which like reference numerals identify similar or identical elements. Reference numerals that are introduced in the specification in association with a drawing figure may be repeated in one or more subsequent figures without additional description in the specification in order to provide context for other features, and not every element may be labeled in every figure. The drawing figures are not necessarily to scale, emphasis instead being placed upon illustrating embodiments, principles and concepts. The drawings are not intended to limit the scope of the claims included herewith.

FIG. 1A is a block diagram of a network computing system, in accordance with an illustrative embodiment;

FIG. 1B is a block diagram of a network computing system for delivering a computing environment from a server to a client via an appliance, in accordance with an illustrative embodiment;

FIG. 1C is a block diagram of a computing device, in accordance with an illustrative embodiment;

FIG. 2 is a block diagram of an appliance for processing communications between a client and a server, in accordance with an illustrative embodiment;

FIG. 3 is a block diagram of a virtualization environment, in accordance with an illustrative embodiment;

FIG. 4 is a block diagram of a cluster system, in accordance with an illustrative embodiment;

FIG. 5 is a block diagram of a system for analyzing process and resource metrics across client devices, in accordance with an illustrative embodiment;

FIG. 6 is a process flow for analyzing process and resource metrics across client devices, in accordance with an illustrative embodiment;

FIG. 7 is a process flow of selecting processes across sites and delivery groups, according to an illustrative embodiment;

FIG. 8 is an example table representing aggregated data from a plurality of client devices 502, in accordance with an illustrative embodiment;

FIG. 9 is an example table showing data that may be included in an alert, in accordance with an illustrative embodiment; and

FIG. 10 a flow diagram showing a method 1000 for analyzing process and resource metrics across client devices, in accordance with an illustrative embodiment.

The features and advantages of the present solution will become more apparent from the detailed description set forth below when taken in conjunction with the drawings, in which like reference characters identify corresponding elements throughout. In the drawings, like reference numbers generally indicate identical, functionally similar, and/or structurally similar elements

### DETAILED DESCRIPTION

During operation of a client device, the client device may execute various processes, such as applications, resources, background executables, etc. Each of the processes executing on the client may consume or utilize a certain amount of computing resources (such as central processing unit (CPU) resources, graphics processing unit (GPU) resources, memory, disk space, network throughput, power, etc.). Some analytics services may offer infrastructure analytics that show administrators different client devices and workload. Such infrastructure analytics may provide visibility into each client device's resource trend along with, for example, the top processes that are contributing to or causing a spike in resource consumption. Some infrastructure analytics may provide an option to perform actions on a particular client device. However, such infrastructure analytics may not work at scale for a virtualized environment where an enterprise has (for instance) thousands of client devices spanning across multiple delivery groups and sites.

According to the systems and methods of the present solution, a resource manager (e.g., executing on a server) may receive metrics on resource utilization of a plurality of processes executing on at least some of a plurality of client devices. The resource manager may select a subset of the processes based on the metrics (e.g., received from the client devices). The resource management server may determine a subset of client devices which are executing the selected processes, and generate an alert which identifies the subset of processes and subset of client devices.

In various embodiments of the present solution, the resource manager may receive metrics across all client devices of an enterprise, and identify the top processes (including durations in which those processes were executing) which are causing spikes in resource consumptions across sites and delivery groups and correspondingly causing poor user experiences to employees using those client devices. The resource manager may generate alerts (e.g., on user interfaces or notifications) for an administrator computing device. As such, an administrator computing device may render data corresponding to processes which occur consistently across the enterprise. Additionally, where processes are mandatory (such as mandatory security scans or tools), the administrator may change the schedule of those processes to the extent execution of such processes hinder day-to-day operation of the client devices. The resource manager may also maintain policies corresponding to black or white-listed processes, which may include malicious processes that are to be blocked and/or processes which are mandatory.

The resource manager may receive metrics on resource data and process data for each of the client devices. In some embodiments, the resource manager may receive the metrics directly from the client devices, or from another component or element that maintains such data (such as a traffic management service to which the client devices report such data). The resource manager may receive the data at different intervals (such as the resource data every five minutes, and process data every ten minutes, for example). With the combination of both the resource data and process data, the resource manager may identify the top processes (e.g., cross client devices) that are contributing to resource utilization. The resource manager may identify processes that cause or contribute to increased resource utilization across delivery groups and/or sites. The resource manager may categorize the processes into various categories/application types within the delivery group level that are contributing to higher usage for a certain percentage of users/client devices. The resource manager may generate alerts or notifications for an administrator computing device which processes are contributing to resource utilization, such that an administrator can determine whether there are any alternative processes that could be executed that reduce resource utilization. Additionally, the resource, process, and/or categorized data may be stored or maintained in one or more data structures or databases for root cause analysis (RCA).

For purposes of reading the description of the various embodiments below, the following descriptions of the sections of the specification and their respective contents may be helpful:
Section A describes a network environment and computing environment which may be useful for practicing embodiments described herein;
Section B describes embodiments of systems and methods for delivering a computing environment to a remote user;
Section C describes embodiments of systems and methods for virtualizing an application delivery controller;
Section D describes embodiments of systems and methods for providing a clustered appliance architecture environment; and
Section E describes embodiments of systems and methods for analyzing process and resource metrics across client devices.

### A. Network and Computing Environment

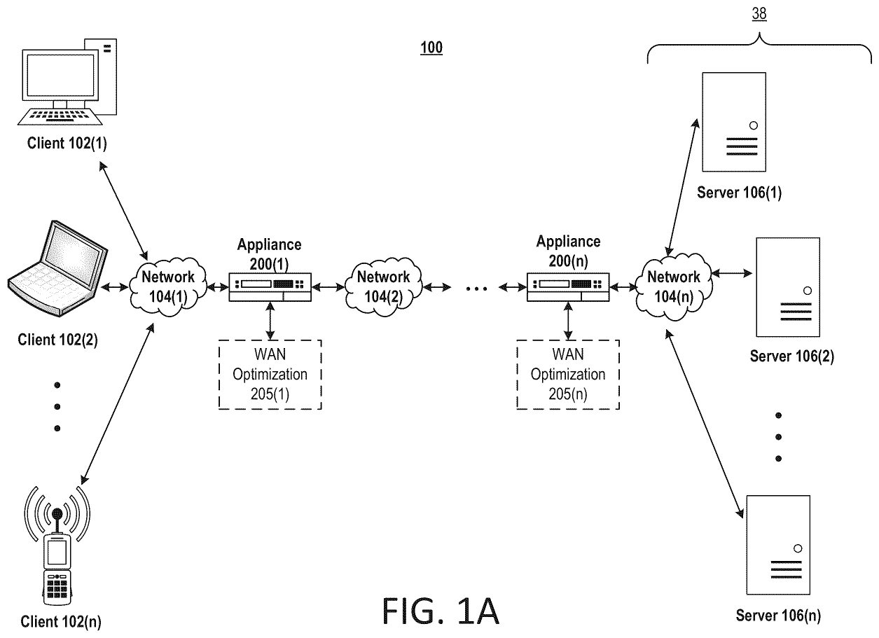

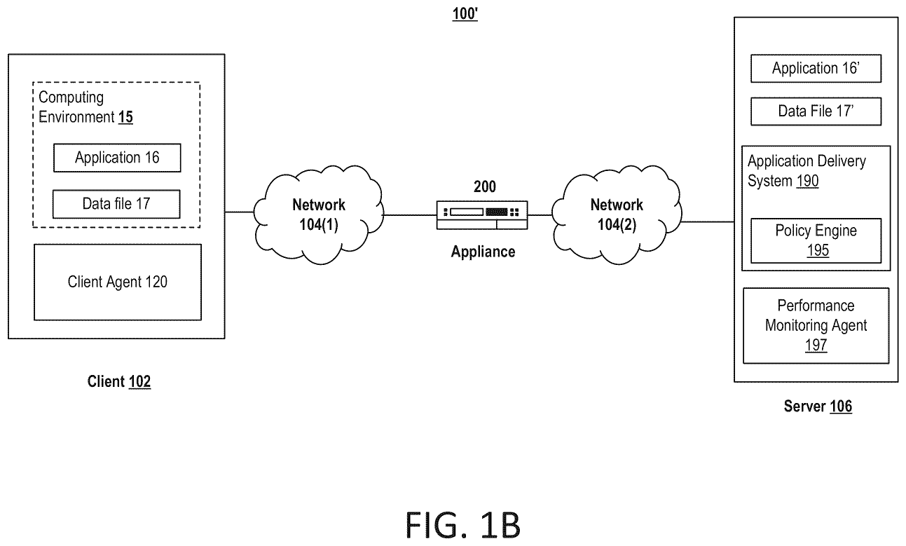

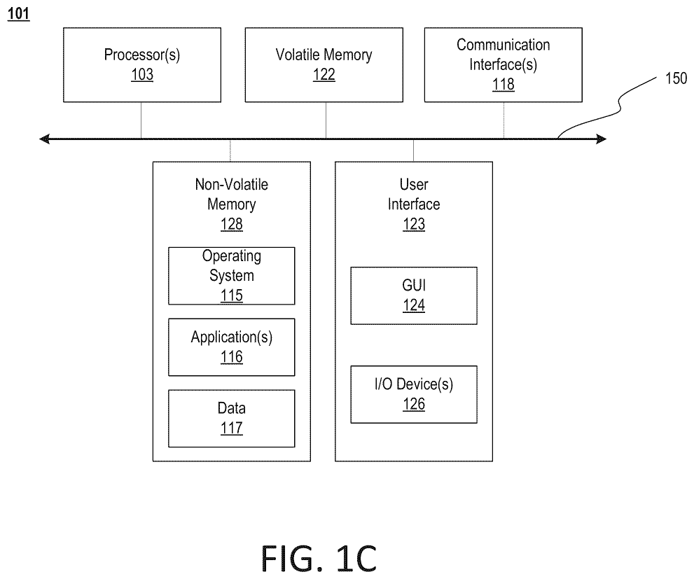

Referring to FIG. 1A, an illustrative network environment 100 is depicted. Network environment 100 may include one or more clients 102(1)-102(n) (also generally referred to as local machine(s) 102 or client(s) 102) in communication with one or more servers 106(1)-106(n) (also generally referred to as remote machine(s) 106 or server(s) 106) via one or more networks 104(1)-104n (generally referred to as network(s) 104). In some embodiments, a client 102 may communicate with a server 106 via one or more appliances 200(1)-200n (generally referred to as appliance(s) 200 or gateway(s) 200).

Although the embodiment shown in FIG. 1A shows one or more networks 104 between clients 102 and servers 106, in other embodiments, clients 102 and servers 106 may be on the same network 104. The various networks 104 may be the same type of network or different types of networks. For example, in some embodiments, network 104(1) may be a private network such as a local area network (LAN) or a company Intranet, while network 104(2) and/or network 104(n) may be a public network, such as a wide area network (WAN) or the Internet. In other embodiments, both network 104(1) and network 104(n) may be private networks. Networks 104 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols.

As shown in FIG. 1A, one or more appliances 200 may be located at various points or in various communication paths of network environment 100. For example, appliance 200 may be deployed between two networks 104(1) and 104(2), and appliances 200 may communicate with one another to work in conjunction to, for example, accelerate network traffic between clients 102 and servers 106. In other embodiments, the appliance 200 may be located on a network 104. For example, appliance 200 may be implemented as part of one of clients 102 and/or servers 106. In an embodiment, appliance 200 may be implemented as a network device such as NetScaler® products sold by Citrix Systems, Inc. of Fort Lauderdale, FL.

As shown in FIG. 1A, one or more servers 106 may operate as a server farm 38. Servers 106 of server farm 38 may be logically grouped, and may either be geographically co-located (e.g., on premises) or geographically dispersed (e.g., cloud based) from clients 102 and/or other servers 106. In an embodiment, server farm 38 executes one or more applications on behalf of one or more of clients 102 (e.g., as an application server), although other uses are possible, such as a file server, gateway server, proxy server, or other similar server uses. Clients 102 may seek access to hosted applications on servers 106.

As shown in FIG. 1A, in some embodiments, appliances 200 may include, be replaced by, or be in communication with, one or more additional appliances, such as WAN optimization appliances 205(1)-205(n), referred to generally as WAN optimization appliance(s) 205. For example, WAN optimization appliance 205 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, appliance 205 may be a performance enhancing proxy or a WAN optimization controller. In one embodiment, appliance 205 may be implemented as CloudBridge® products sold by Citrix Systems, Inc. of Fort Lauderdale, FL.

Referring to FIG. 1B, an example network environment 100′ for delivering and/or operating a computing network environment on a client 102 is shown. As shown in FIG. 1B, a server 106 may include an application delivery system 190 for delivering a computing environment, application, and/or data files to one or more clients 102. Client 102 may include client agent 120 and computing environment 15. Computing environment 15 may execute or operate an application 16, that accesses, processes or uses a data file 17. Computing environment 15, application 16 and/or data file 17 may be delivered to the client 102 via appliance 200 and/or the server 106.

Appliance 200 may accelerate delivery of all or a portion of computing environment 15 to a client 102, for example by the application delivery system 190. For example, appliance 200 may accelerate delivery of a streaming application and data file processable by the application from a data center to a remote user location by accelerating transport layer traffic between a client 102 and a server 106. Such acceleration may be provided by one or more techniques, such as: 1) transport layer connection pooling, 2) transport layer connection multiplexing, 3) transport control protocol buffering, 4) compression, 5) caching, or other techniques. Appliance 200 may also provide load balancing of servers 106 to process requests from clients 102, act as a proxy or access server to provide access to the one or more servers 106, provide security and/or act as a firewall between a client 102 and a server 106, provide Domain Name Service (DNS) resolution, provide one or more virtual servers or virtual internet protocol servers, and/or provide a secure virtual private network (VPN) connection from a client 102 to a server 106, such as a secure socket layer (SSL) VPN connection and/or provide encryption and decryption operations.

Application delivery management system 190 may deliver computing environment to a user (e.g., client 102), remote or otherwise, based on authentication and authorization policies applied by policy engine 195. A remote user may obtain a computing environment and access to server stored applications and data files from any network-connected device (e.g., client 102). For example, appliance 200 may request an application and data file from server 106. In response to the request, application delivery system 190 and/or server 106 may deliver the application and data file to client 102, for example via an application stream to operate in computing environment 15 on client 102, or via a remote-display protocol or otherwise via remote-based or server-based computing. In an embodiment, application delivery system 190 may be implemented as any portion of the Citrix Workspace Suite™ by Citrix Systems, Inc., such as XenApp® or XenDesktop®.

Policy engine 195 may control and manage the access to, and execution and delivery of, applications. For example, policy engine 195 may determine the one or more applications a user or client 102 may access and/or how the application should be delivered to the user or client 102, such as a server-based computing, streaming or delivering the application locally to the client 50 for local execution.

For example, in operation, a client 102 may request execution of an application (e.g., application 16′) and application delivery system 190 of server 106 determines how to execute application 16′, for example based upon credentials received from client 102 and a user policy applied by policy engine 195 associated with the credentials. For example, application delivery system 190 may enable client 102 to receive application-output data generated by execution of the application on a server 106, may enable client 102 to execute the application locally after receiving the application from server 106, or may stream the application via network 104 to client 102. For example, in some embodiments, the application may be a server-based or a remote-based application executed on server 106 on behalf of client 102. Server 106 may display output to client 102 using a thin-client or remote-display protocol, such as the Independent Computing Architecture (ICA) protocol by Citrix Systems, Inc. of Fort Lauderdale, FL. The application may be any application related to real-time data communications, such as applications for streaming graphics, streaming video and/or audio or other data, delivery of remote desktops or workspaces or hosted services or applications, for example infrastructure as a service (IaaS), workspace as a service (WaaS), software as a service (SaaS) or platform as a service (PaaS).

One or more of servers 106 may include a performance monitoring service or agent 197. In some embodiments, a dedicated one or more servers 106 may be employed to perform performance monitoring. Performance monitoring may be performed using data collection, aggregation, analysis, management and reporting, for example by software, hardware or a combination thereof. Performance monitoring may include one or more agents for performing monitoring, measurement and data collection activities on clients 102 (e.g., client agent 120), servers 106 (e.g., agent 197) or an appliances 200 and/or 205 (agent not shown). In general, monitoring agents (e.g., 120 and/or 197) execute transparently (e.g., in the background) to any application and/or user of the device. In some embodiments, monitoring agent 197 includes any of the product embodiments referred to as EdgeSight by Citrix Systems, Inc. of Fort Lauderdale, FL.

The monitoring agents 120 and 197 may monitor, measure, collect, and/or analyze data on a predetermined frequency, based upon an occurrence of given event(s), or in real time during operation of network environment 100. The monitoring agents may monitor resource consumption and/or performance of hardware, software, and/or communications resources of clients 102, networks 104, appliances 200 and/or 205, and/or servers 106. For example, network connections such as a transport layer connection, network latency, bandwidth utilization, end-user response times, application usage and performance, session connections to an application, cache usage, memory usage, processor usage, storage usage, database transactions, client and/or server utilization, active users, duration of user activity, application crashes, errors, or hangs, the time required to log-in to an application, a server, or the application delivery system, and/or other performance conditions and metrics may be monitored.

The monitoring agents 120 and 197 may provide application performance management for application delivery system 190. For example, based upon one or more monitored performance conditions or metrics, application delivery system 190 may be dynamically adjusted, for example periodically or in real-time, to optimize application delivery by servers 106 to clients 102 based upon network environment performance and conditions.

In described embodiments, clients 102, servers 106, and appliances 200 and 205 may be deployed as and/or executed on any type and form of computing device, such as any desktop computer, laptop computer, or mobile device capable of communication over at least one network and performing the operations described herein. For example, clients 102, servers 106 and/or appliances 200 and 205 may each correspond to one computer, a plurality of computers, or a network of distributed computers such as computer 101 shown in FIG. 1C.

As shown in FIG. 1C, computer 101 may include one or more processors 103, volatile memory 122 (e.g., RAM), non-volatile memory 128 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), user interface (UI) 123, one or more communications interfaces 118, and communication bus 150. User interface 123 may include graphical user interface (GUI) 124 (e.g., a touchscreen, a display, etc.) and one or more input/output (I/O) devices 126 (e.g., a mouse, a keyboard, etc.). Non-volatile memory 128 stores operating system 115, one or more applications 116, and data 117 such that, for example, computer instructions of operating system 115 and/or applications 116 are executed by processor(s) 103 out of volatile memory 122. Data may be entered using an input device of GUI 124 or received from I/O device(s) 126. Various elements of computer 101 may communicate via communication bus 150. Computer 101 as shown in FIG. 1C is shown merely as an example, as clients 102, servers 106 and/or appliances 200 and 205 may be implemented by any computing or processing environment and with any type of machine or set of machines that may have suitable hardware and/or software capable of operating as described herein.

Processor(s) 103 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

Communications interfaces 118 may include one or more interfaces to enable computer 101 to access a computer network such as a LAN, a WAN, or the Internet through a variety of wired and/or wireless or cellular connections.

In described embodiments, a first computing device 101 may execute an application on behalf of a user of a client computing device (e.g., a client 102), may execute a virtual machine, which provides an execution session within which applications execute on behalf of a user or a client computing device (e.g., a client 102), such as a hosted desktop session, may execute a terminal services session to provide a hosted desktop environment, or may provide access to a computing environment including one or more of: one or more applications, one or more desktop applications, and one or more desktop sessions in which one or more applications may execute.

### B. Appliance Architecture

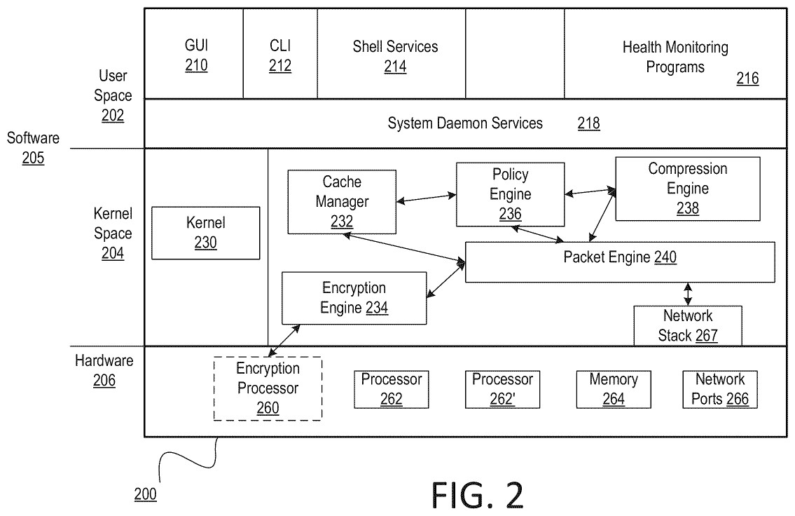

FIG. 2 shows an example embodiment of appliance 200. As described herein, appliance 200 may be implemented as a server, gateway, router, switch, bridge or other type of computing or network device. As shown in FIG. 2, an embodiment of appliance 200 may include a hardware layer 206 and a software layer 205 divided into a user space 202 and a kernel space 204. Hardware layer 206 provides the hardware elements upon which programs and services within kernel space 204 and user space 202 are executed and allow programs and services within kernel space 204 and user space 202 to communicate data both internally and externally with respect to appliance 200. As shown in FIG. 2, hardware layer 206 may include one or more processing units 262 for executing software programs and services, memory 264 for storing software and data, network ports 266 for transmitting and receiving data over a network, and encryption processor 260 for encrypting and decrypting data such as in relation to Secure Socket Layer (SSL) or Transport Layer Security (TLS) processing of data transmitted and received over the network.

An operating system of appliance 200 allocates, manages, or otherwise segregates the available system memory into kernel space 204 and user space 202. Kernel space 204 is reserved for running kernel 230, including any device drivers, kernel extensions or other kernel related software. As known to those skilled in the art, kernel 230 is the core of the operating system, and provides access, control, and management of resources and hardware-related elements of application. Kernel space 204 may also include a number of network services or processes working in conjunction with cache manager 232.

Appliance 200 may include one or more network stacks 267, such as a TCP/IP based stack, for communicating with client(s) 102, server(s) 106, network(s) 104, and/or other appliances 200 or 205. For example, appliance 200 may establish and/or terminate one or more transport layer connections between clients 102 and servers 106. Each network stack 267 may include a buffer for queuing one or more network packets for transmission by appliance 200.

Kernel space 204 may include cache manager 232, packet engine 240, encryption engine 234, policy engine 236 and compression engine 238. In other words, one or more of processes 232, 240, 234, 236 and 238 run in the core address space of the operating system of appliance 200, which may reduce the number of data transactions to and from the memory and/or context switches between kernel mode and user mode, for example since data obtained in kernel mode may not need to be passed or copied to a user process, thread or user level data structure.

Cache manager 232 may duplicate original data stored elsewhere or data previously computed, generated or transmitted to reduce the access time of the data. In some embodiments, the cache manager 232 may be a data object in memory 264 of appliance 200, or may be a physical memory having a faster access time than memory 264.

Policy engine 236 may include a statistical engine or other configuration mechanism to allow a user to identify, specify, define or configure a caching policy and access, control and management of objects, data or content being cached by appliance 200, and define or configure security, network traffic, network access, compression or other functions performed by appliance 200.

Encryption engine 234 may process any security related protocol, such as SSL or TLS. For example, encryption engine 234 may encrypt and decrypt network packets, or any portion thereof, communicated via appliance 200, may setup or establish SSL, TLS or other secure connections, for example between client 102, server 106, and/or other appliances 200 or 205. In some embodiments, encryption engine 234 may use a tunneling protocol to provide a VPN between a client 102 and a server 106. In some embodiments, encryption engine 234 is in communication with encryption processor 260. Compression engine 238 compresses network packets bi-directionally between clients 102 and servers 106 and/or between one or more appliances 200.

Packet engine 240 may manage kernel-level processing of packets received and transmitted by appliance 200 via network stacks 267 to send and receive network packets via network ports 266. Packet engine 240 may operate in conjunction with encryption engine 234, cache manager 232, policy engine 236 and compression engine 238, for example to perform encryption/decryption, traffic management such as request-level content switching and request-level cache redirection, and compression and decompression of data.

User space 202 is a memory area or portion of the operating system used by user mode applications or programs otherwise running in user mode. A user mode application may not access kernel space 204 directly and uses service calls in order to access kernel services. User space 202 may include graphical user interface (GUI) 210, a command line interface (CLI) 212, shell services 214, health monitor 216, and daemon services 218. GUI 210 and CLI 212 enable a system administrator or other user to interact with and control the operation of appliance 200, such as via the operating system of appliance 200. Shell services 214 include programs, services, tasks, processes or executable instructions to support interaction with appliance 200 by a user via the GUI 210 and/or CLI 212.

Health monitor 216 monitors, checks, reports and ensures that network systems are functioning properly and that users are receiving requested content over a network, for example by monitoring activity of appliance 200. In some embodiments, health monitor 216 intercepts and inspects any network traffic passed via appliance 200. For example, health monitor 216 may interface with one or more of encryption engine 234, cache manager 232, policy engine 236, compression engine 238, packet engine 240, daemon services 218, and shell services 214 to determine a state, status, operating condition, or health of any portion of the appliance 200. Further, health monitor 216 may determine whether a program, process, service or task is active and currently running, check status, error or history logs provided by any program, process, service or task to determine any condition, status or error with any portion of appliance 200. Additionally, health monitor 216 may measure and monitor the performance of any application, program, process, service, task or thread executing on appliance 200.

Daemon services 218 are programs that run continuously or in the background and handle periodic service requests received by appliance 200. In some embodiments, a daemon service may forward the requests to other programs or processes, such as another daemon service 218 as appropriate.

As described herein, appliance 200 may relieve servers 106 of much of the processing load caused by repeatedly opening and closing transport layers connections to clients 102 by opening one or more transport layer connections with each server 106 and maintaining these connections to allow repeated data accesses by clients via the Internet (e.g., “connection pooling”). To perform connection pooling, appliance 200 may translate or multiplex communications by modifying sequence numbers and acknowledgment numbers at the transport layer protocol level (e.g., “connection multiplexing”). Appliance 200 may also provide switching or load balancing for communications between the client 102 and server 106.

As described herein, each client 102 may include client agent 120 for establishing and exchanging communications with appliance 200 and/or server 106 via a network 104. Client 102 may have installed and/or execute one or more applications that are in communication with network 104. Client agent 120 may intercept network communications from a network stack used by the one or more applications. For example, client agent 120 may intercept a network communication at any point in a network stack and redirect the network communication to a destination desired, managed or controlled by client agent 120, for example to intercept and redirect a transport layer connection to an IP address and port controlled or managed by client agent 120. Thus, client agent 120 may transparently intercept any protocol layer below the transport layer, such as the network layer, and any protocol layer above the transport layer, such as the session, presentation or application layers. Client agent 120 can interface with the transport layer to secure, optimize, accelerate, route or load-balance any communications provided via any protocol carried by the transport layer.

In some embodiments, client agent 120 is implemented as an Independent Computing Architecture (ICA) client developed by Citrix Systems, Inc. of Fort Lauderdale, FL. Client agent 120 may perform acceleration, streaming, monitoring, and/or other operations. For example, client agent 120 may accelerate streaming an application from a server 106 to a client 102. Client agent 120 may also perform end-point detection/scanning and collect end-point information about client 102 for appliance 200 and/or server 106. Appliance 200 and/or server 106 may use the collected information to determine and provide access, authentication and authorization control of the client's connection to network 104. For example, client agent 120 may identify and determine one or more client-side attributes, such as: the operating system and/or a version of an operating system, a service pack of the operating system, a running service, a running process, a file, presence or versions of various applications of the client, such as antivirus, firewall, security, and/or other software.

### C. Systems and Methods for Providing Virtualized Application Delivery Controller

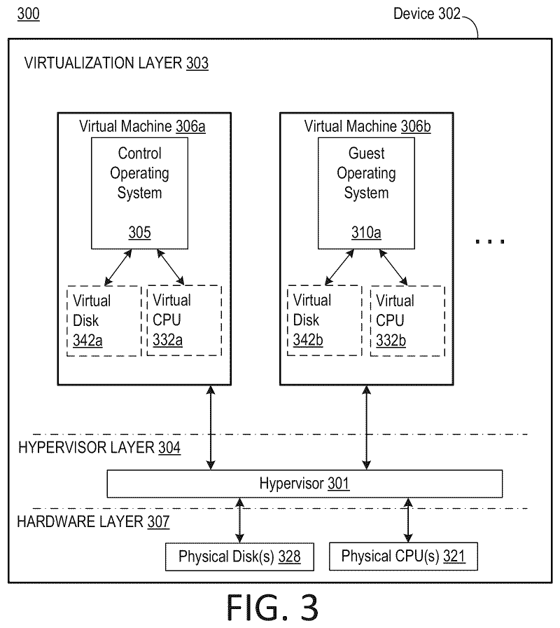

Referring now to FIG. 3, a block diagram of a virtualized environment 300 is shown. As shown, a computing device 302 in virtualized environment 300 includes a virtualization layer 303, a hypervisor layer 304, and a hardware layer 307. Hypervisor layer 304 includes one or more hypervisors (or virtualization managers) 301 that allocates and manages access to a number of physical resources in hardware layer 307 (e.g., physical processor(s) 321 and physical disk(s) 328) by at least one virtual machine (VM) (e.g., one of VMs 306) executing in virtualization layer 303. Each VM 306 may include allocated virtual resources such as virtual processors 332 and/or virtual disks 342, as well as virtual resources such as virtual memory and virtual network interfaces. In some embodiments, at least one of VMs 306 may include a control operating system (e.g., 305) in communication with hypervisor 301 and used to execute applications for managing and configuring other VMs (e.g., guest operating systems 310) on device 302.

In general, hypervisor(s) 301 may provide virtual resources to an operating system of VMs 306 in any manner that simulates the operating system having access to a physical device. Thus, hypervisor(s) 301 may be used to emulate virtual hardware, partition physical hardware, virtualize physical hardware, and execute virtual machines that provide access to computing environments. In an illustrative embodiment, hypervisor(s) 301 may be implemented as a XEN hypervisor, for example as provided by the open source Xen.org community. In an illustrative embodiment, device 302 executing a hypervisor that creates a virtual machine platform on which guest operating systems may execute is referred to as a host server. In such an embodiment, device 302 may be implemented as a XEN server as provided by Citrix Systems, Inc., of Fort Lauderdale, FL.

Hypervisor 301 may create one or more VMs 306 in which an operating system (e.g., control operating system 305 and/or guest operating system 310) executes. For example, the hypervisor 301 loads a virtual machine image to create VMs 306 to execute an operating system. Hypervisor 301 may present VMs 306 with an abstraction of hardware layer 307, and/or may control how physical capabilities of hardware layer 307 are presented to VMs 306. For example, hypervisor(s) 301 may manage a pool of resources distributed across multiple physical computing devices.

In some embodiments, one of VMs 306 (e.g., the VM executing control operating system 305) may manage and configure other of VMs 306, for example by managing the execution and/or termination of a VM and/or managing allocation of virtual resources to a VM. In various embodiments, VMs may communicate with hypervisor(s) 301 and/or other VMs via, for example, one or more Application Programming Interfaces (APIs), shared memory, and/or other techniques.

In general, VMs 306 may provide a user of device 302 with access to resources within virtualized computing environment 300, for example, one or more programs, applications, documents, files, desktop and/or computing environments, or other resources. In some embodiments, VMs 306 may be implemented as fully virtualized VMs that are not aware that they are virtual machines (e.g., a Hardware Virtual Machine or HVM). In other embodiments, the VM may be aware that it is a virtual machine, and/or the VM may be implemented as a paravirtualized (PV) VM.

Although shown in FIG. 3 as including a single virtualized device 302, virtualized environment 300 may include a plurality of networked devices in a system in which at least one physical host executes a virtual machine. A device on which a VM executes may be referred to as a physical host and/or a host machine. For example, appliance 200 may be additionally or alternatively implemented in a virtualized environment 300 on any computing device, such as a client 102, server 106 or appliance 200. Virtual appliances may provide functionality for availability, performance, health monitoring, caching and compression, connection multiplexing and pooling and/or security processing (e.g., firewall, VPN, encryption/decryption, etc.), similarly as described in regard to appliance 200.

In some embodiments, a server may execute multiple virtual machines 306, for example on various cores of a multi-core processing system and/or various processors of a multiple processor device. For example, although generally shown herein as “processors” (e.g., in FIGS. 1C, 2 and 3), one or more of the processors may be implemented as either single- or multi-core processors to provide a multi-threaded, parallel architecture and/or multi-core architecture. Each processor and/or core may have or use memory that is allocated or assigned for private or local use that is only accessible by that processor/core, and/or may have or use memory that is public or shared and accessible by multiple processors/cores. Such architectures may allow work, task, load or network traffic distribution across one or more processors and/or one or more cores (e.g., by functional parallelism, data parallelism, flow-based data parallelism, etc.).

Further, instead of (or in addition to) the functionality of the cores being implemented in the form of a physical processor/core, such functionality may be implemented in a virtualized environment (e.g., 300) on a client 102, server 106 or appliance 200, such that the functionality may be implemented across multiple devices, such as a cluster of computing devices, a server farm or network of computing devices, etc. The various processors/cores may interface or communicate with each other using a variety of interface techniques, such as core to core messaging, shared memory, kernel APIs, etc.

In embodiments employing multiple processors and/or multiple processor cores, described embodiments may distribute data packets among cores or processors, for example to balance the flows across the cores. For example, packet distribution may be based upon determinations of functions performed by each core, source and destination addresses, and/or whether: a load on the associated core is above a predetermined threshold; the load on the associated core is below a predetermined threshold; the load on the associated core is less than the load on the other cores; or any other metric that can be used to determine where to forward data packets based in part on the amount of load on a processor.

For example, data packets may be distributed among cores or processes using receive-side scaling (RSS) in order to process packets using multiple processors/cores in a network. RSS generally allows packet processing to be balanced across multiple processors/cores while maintaining in-order delivery of the packets. In some embodiments, RSS may use a hashing scheme to determine a core or processor for processing a packet.

The RSS may generate hashes from any type and form of input, such as a sequence of values. This sequence of values can include any portion of the network packet, such as any header, field or payload of network packet, and include any tuples of information associated with a network packet or data flow, such as addresses and ports. The hash result or any portion thereof may be used to identify a processor, core, engine, etc., for distributing a network packet, for example via a hash table, indirection table, or other mapping technique.

### D. Systems and Methods for Providing a Distributed Cluster Architecture

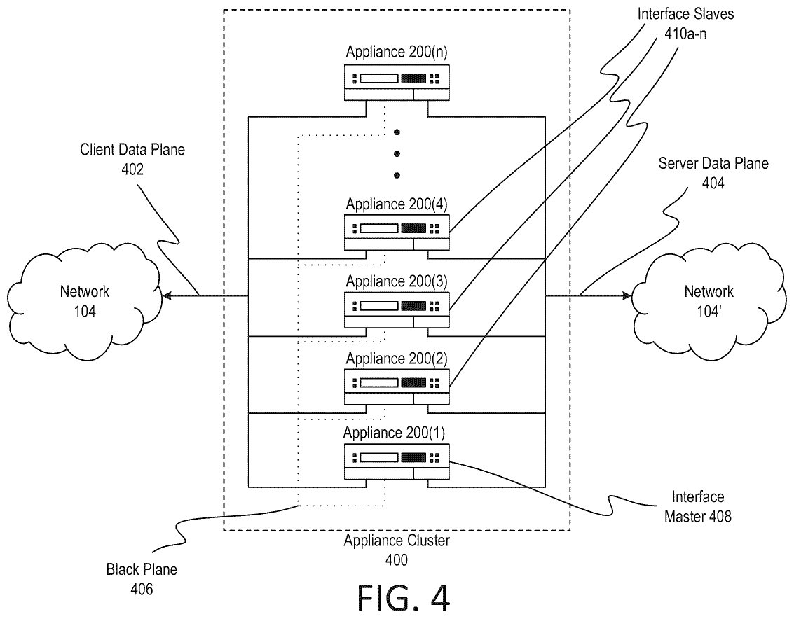

Although shown in FIGS. 1A and 1B as being single appliances, appliances 200 may be implemented as one or more distributed or clustered appliances. Individual computing devices or appliances may be referred to as nodes of the cluster. A centralized management system may perform load balancing, distribution, configuration, or other tasks to allow the nodes to operate in conjunction as a single computing system. Such a cluster may be viewed as a single virtual appliance or computing device. FIG. 4 shows a block diagram of an illustrative computing device cluster or appliance cluster 400. A plurality of appliances 200 or other computing devices (e.g., nodes) may be joined into a single cluster 400. Cluster 400 may operate as an application server, network storage server, backup service, or any other type of computing device to perform many of the functions of appliances 200 and/or 205.

In some embodiments, each appliance 200 of cluster 400 may be implemented as a multi-processor and/or multi-core appliance, as described herein. Such embodiments may employ a two-tier distribution system, with one appliance if the cluster distributing packets to nodes of the cluster, and each node distributing packets for processing to processors/cores of the node. In many embodiments, one or more of appliances 200 of cluster 400 may be physically grouped or geographically proximate to one another, such as a group of blade servers or rack mount devices in a given chassis, rack, and/or data center. In some embodiments, one or more of appliances 200 of cluster 400 may be geographically distributed, with appliances 200 not physically or geographically co-located. In such embodiments, geographically remote appliances may be joined by a dedicated network connection and/or VPN. In geographically distributed embodiments, load balancing may also account for communications latency between geographically remote appliances.

In some embodiments, cluster 400 may be considered a virtual appliance, grouped via common configuration, management, and purpose, rather than as a physical group. For example, an appliance cluster may comprise a plurality of virtual machines or processes executed by one or more servers.

As shown in FIG. 4, appliance cluster 400 may be coupled to a client-side network 104 via client data plane 402, for example to transfer data between clients 102 and appliance cluster 400. Client data plane 402 may be implemented a switch, hub, router, or other similar network device internal or external to cluster 400 to distribute traffic across the nodes of cluster 400. For example, traffic distribution may be performed based on equal-cost multi-path (ECMP) routing with next hops configured with appliances or nodes of the cluster, open-shortest path first (OSPF), stateless hash-based traffic distribution, link aggregation (LAG) protocols, or any other type and form of flow distribution, load balancing, and routing.

Appliance cluster 400 may be coupled to a second network 104′ via server data plane 404. Similarly to client data plane 402, server data plane 404 may be implemented as a switch, hub, router, or other network device that may be internal or external to cluster 400. In some embodiments, client data plane 402 and server data plane 404 may be merged or combined into a single device.

In some embodiments, each appliance 200 of cluster 400 may be connected via an internal communication network or back plane 406. Back plane 406 may enable inter-node or inter-appliance control and configuration messages, for inter-node forwarding of traffic, and/or for communicating configuration and control traffic from an administrator or user to cluster 400. In some embodiments, back plane 406 may be a physical network, a VPN or tunnel, or a combination thereof.

### E. Systems and Methods for Analyzing Process and Resource Metrics Across Client Devices

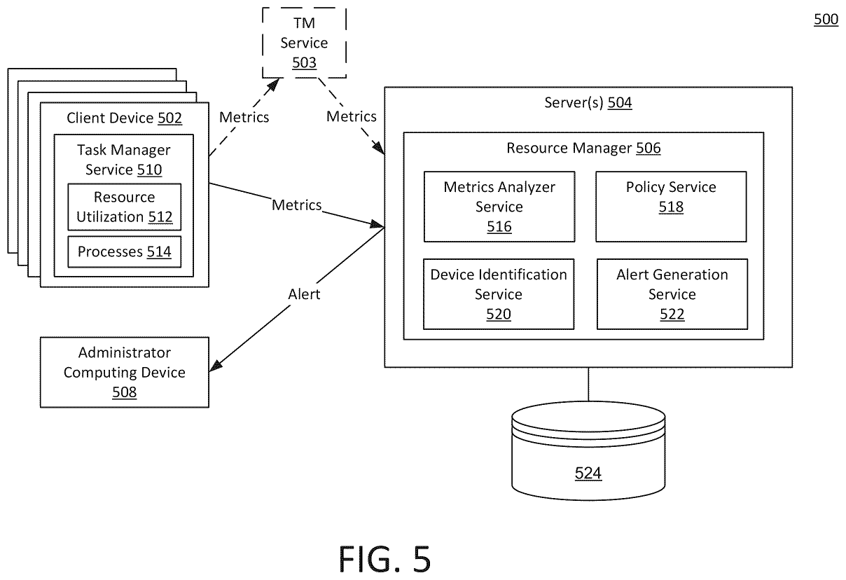

Referring now to FIG. 5, depicted is a system 500 for analyzing process and resource metrics across client devices, in accordance with an illustrative embodiment. The system 500 may include a plurality of client devices 502, one or more server(s) 504 hosting or otherwise executing a resource manager 506, and an administrator computing device 508. As a brief overview of the system 500, the client devices 502 may each include a task manager service 510 configured to determine metrics corresponding to resource utilization 512 of the client device 502 and processes 514 executing on the client device 502. The task manager service 510 may be configured to provide the metrics to the resource manager 506. A metrics analyzer service 516 of the resource manager 506 may be configured to receive the metrics on resource utilization 512 of a plurality of processes 514 executing across the client devices 502. The metrics analyzer service 516 may be configured to select a subset of the processes 514 based on the metrics. In some embodiments, a policy service 518 may apply various policies (e.g., defined or set by the administrator computing device 508 for example) to the processes 514 as part of selection of the subset of processes 514. A device identification service 520 may identify a subset of the client devices 502 which are executing the subset of processes 514. An alert generation service 522 may generate an alert which identifies the subset of processes 514 and the subset of client devices 502 which are executing the processes 514. The resource manager 506 may store data corresponding to the metrics (e.g., the resource utilization 512, processes 514, subset of processes 514 and corresponding client devices 502, etc.) on one or more databases 524.

As shown in FIG. 5, the system 500 may include a plurality of client devices 502 and an administrator computing device 508. The client devices 502 and administrator computing device 508 may be similar to the clients 102 described above with reference to FIG. 1A-FIG. 1B. The server(s) 504 may be similar to the server(s) 106 described above with reference to FIG. 1A-FIG. 1B. The client devices 502, administrator computing device 508, and/or server(s) 504 may include elements similar to those described above with reference to FIG. 1C. In some embodiments, the client devices 502 may be associated with an enterprise managed by the administrator computing device 508. For example, the client devices 502 may each be managed by an enterprise (e.g., a company, business, organization, etc.). In some embodiments, some of the client devices 502 may access a virtualized environment provided by the enterprise as described above with reference to FIG. 3. The client devices 502 may be located across geographic locations and access resources at various different data centers or sites. For example, the client devices 502 may be distributed across various geographic locations corresponding to the enterprise, and access a given resource through different data centers (or sites) and delivery groups within sites, depending on a geographic location of the client device 502 relative to the site.

The client devices 502 may each include a respective task manager service 510. The task manager service 510 may be or include any device, component, element, or service executing on the client device 502 and configured to collect metrics or data on resource utilization 512 and processes 514 executing on the client device 502. In some embodiments, the task manager service 510 may execute in the background of the client device 502 and collect the metrics on resource utilization 512 and processes 514. The metrics on resource utilization 512 may include, for example, central processing unit (CPU) percentage utilization, speed, etc., graphics processing unit (GPU) usage, memory usage or composition, disk space, network throughput, input/output operations per second (IOPS), and so forth. The metrics on processes 514 may be or include a list of applications, background processes, operating system (OS) processes, enterprise processes, virtualized processes, etc. executing on the client device 502. In some embodiments, the task manager service 510 may be configured to collect the metrics on resource utilization 512 and processes 514 in real-time (e.g., as the processes 514 execute on the client device 502). In some embodiments, the task manager service 510 may be configured to categorize the processes 514 into one or more categories. For example, the task manager service 510 may be configured to maintain a plurality of different categories for processes which may execute on a given client device 502, including type of process (e.g., application, background process, OS process, enterprise process, virtualized process), sub-types for each type of process (e.g., type of application, type of background process, type of OS process, type of enterprise process, type of virtualized process), etc. The task manager service 510 may be configured to categorize a given process 514 executing on a client device 502 into one or more of the categories by identifying (for instance) a name or identifier of the process 514 and identifying an association (e.g., by performing a look-up, for instance) of the corresponding category (or categories) for the process 514.

In some embodiments, the task manager service 510 may be configured to transmit, send, or otherwise provide the metrics to a traffic management (TM) service 503. The TM service 503 may be or include any device, component, element, or service executing on the client device 502 and configured to collect metrics or data from a plurality of client devices 502. The TM service 503 may be similar to the Intelligent Traffic Management (ITM) service offered by Citrix Systems, Inc. of Fort Lauderdale, FL. In some embodiments, the TM service 503 may execute on or otherwise be provided on a server (such as server(s) 504 or a different server), an appliance (such as appliance 200 described above with reference to FIG. 1A-FIG. 1B, FIG. 2 and/or FIG. 4), or some other device, component, or hardware.

The task manager service 510 may be configured to provide the metrics to the TM service 503 at various reporting intervals (e.g., every five minutes, every ten minutes, every hour, daily, etc.). The TM service 503 may be configured to probe the client devices 502 at various intervals to identify, receive, or otherwise retrieve the metrics on resource utilization 512 and processes 514. The TM service 503 may be configured to receive the metrics from the task manager service 510 executing on the client devices 502. In some embodiments, the task manager service 510 may be configured to provide (and the TM service 503 may be configured to receive) data corresponding to the client devices 502 (e.g., client device identifier, client device name, client device security identifier), data corresponding to the delivery group within a server site or data center (e.g., delivery group name, delivery group ID, etc.) together with the metrics. The TM service 503 may be configured to store or maintain the metrics on one or more data structures. Additionally, and while described above as categorizing being performed by the task manager service 510, in some embodiments, the TM service 503 may be configured to categorize the processes 514 in a manner similar to the task manager service 510 described above.

The server(s) 504 may include a resource manager 506. The resource manager 506 may be or include any device, component, element, or hardware executing on the server(s) 504 and configured to analyze, process, or otherwise manage resource and process utilization across the client devices 502. The resource manager 506 may include various services. The services may be any device, component, element, or service executing on the client device 502 and configured to perform various functions or steps relating to the management of resource and process utilization across the client devices 502. For example, the resource manager service 506 may include a metrics analyzer service 516, a policy service 518, a device identification service 520, and/or an alert generation service 522. While described as separate services, it is noted that various services may be combined into a single service and/or separated into multiple services. As described in greater detail below, the resource manager 506 (e.g., the services of the resource manager 506) may be configured to receive metrics on resource utilization 512 of a plurality of processes 514 executing on the client devices 502, select a subset of the processes 514 based on the metrics, determine which of the client devices 502 are executing the selected subset of processes 514, and generate an alert which identifies the subset of processes 514 and the client devices 502 which are executing the processes 514.

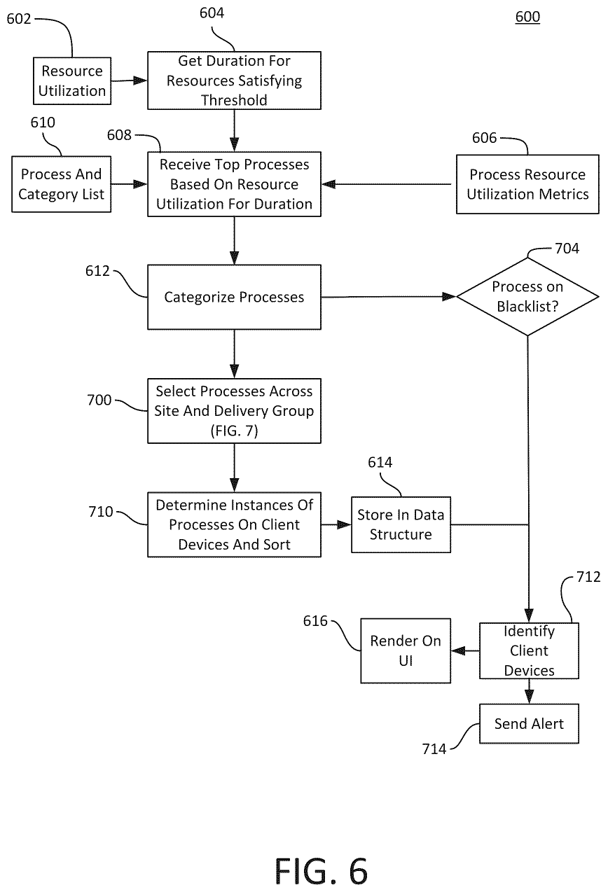

Referring now to FIG. 6 in connection with FIG. 5, depicted is a process flow 600 for analyzing process and resource metrics across client devices, in accordance with an illustrative embodiment. The process flow 600 may be performed by any of the devices/components/elements described above with reference to FIG. 5, including the task manager service 510, the resource manager 506, and/or the TM service 503.

At step 602, the client device 502 may be configured to determine, detect, monitor, or otherwise identify metrics on resource utilization 512. In some embodiments, the task manager service 510 may be configured to identify the metrics on resource utilization 512. The task manager service 510 may be configured to identify the metrics in real-time. The metrics on resource utilization 512 may be or include central processing unit (CPU) percentage utilization, speed, etc., graphics processing unit (GPU) usage, memory usage or composition, disk space, network throughput, input/output operations per second (IOPS), and so forth. In some embodiments, the task manager service 510 may be configured to compare the metrics to one or more resource utilization thresholds. For example, the task manager service 510 may be configured to maintain thresholds, such as peak resource utilization, for each or at least some of the resource utilization metrics (e.g., peak CPU percentage utilization, peak CPU speed, peak GPU usage, peak memory usage or composition, etc.). The task manager service 510 may be configured to compare the identified metrics to the thresholds for resource utilization 512. The task manager service 510 may be configured to identify a duration in which the metrics satisfy (e.g., meet or exceed) the corresponding thresholds. As one example, the task manager service 510 may be configured to identify a duration in which CPU percentage utilization exceeds a corresponding CPU utilization threshold of the corresponding client device 502.

The resource manager 506 may be configured to collect, identify, retrieve, or otherwise receive the metrics on resource utilization 512 from the plurality of client devices 502. In some embodiments, the client devices 502 may be configured to transmit, send, or otherwise provide the metrics on resource utilization 512 to the resource manager 506 (e.g., to an address associated with the resource manager 506). In this regard, the resource manager 506 may be configured to receive the metrics on resource utilization 512 directly from the client devices 502. In some embodiments, the client devices 502 may be configured to transmit, send, or otherwise provide the metrics to the TM service 503 (e.g., to an address of the TM service 503). For example, the TM service 503 may be configured to poll the client devices 502 for the metrics at various intervals, and the client devices 502 may be configured to respond to the poll from the TM service 503 with the metrics on resource utilization 512. The resource manager 506 may be configured to receive the metrics from the TM service 503. In this regard, the resource manager 506 may be configured to receive the metrics indirectly from the client devices 502 through the TM service 503.

At step 604, the resource manager 506 may be configured to receive the duration in which resource utilization on respective client devices 502 satisfy a corresponding threshold. The resource manager 506 may be configured to receive the duration from the task manager service 510 and/or from the TM service 503. The resource manager 506 may be configured to receive the duration at a set, defined, or predetermined interval. For example, the resource manager 506 may be configured to receive the duration (e.g., from the client devices 502 and/or from the TM service 503) every five minutes, through other time intervals may be used including every one minute, two minutes, three minutes, four minutes, ten minutes, 20 minutes, 30 minutes, hour, etc.

At step 606, the resource manager 506 (e.g., the metrics analyzer service 516 of the resource manager 506) may be configured to process the resource utilization 512 metrics. The metrics analyzer service 516 may be configured to process the resource utilization 512 metrics to determine whether the resource utilization 512 of the client devices 502 exceeds thresholds for at least a predetermined duration. As noted above, the resource manager 506 may identify (at step 604) durations from client devices 502 in which resource utilization 512 exceeds a threshold resource utilization. As such, at step 606, the metrics analyzer service 516 may be configured to compare the duration for each of the client devices 502 having resources exceeding a threshold resource utilization to a threshold duration. The metrics analyzer service 516 may be configured to determine whether the duration satisfies the threshold duration (e.g., meets or exceeds the threshold duration). The metrics analyzer service 516 may be configured to identify client devices 502 from each of the plurality of client devices 502 based on the comparison. For example, the metrics analyzer service 516 may be configured to identify a subset of client devices 502 that have resource utilization metrics 510 exceeding a resource utilization threshold for a duration which exceeds the threshold duration.

At step 608, the metrics analyzer service 516 may be configured to obtain, retrieve, or otherwise receive a number of processes from each of the client devices 502 of the subset. In some embodiments, the metrics analyzer service 516 may be configured to send a request to the client devices 502 included in the subset (e.g., that have resource utilization metrics 510 exceeding a resource utilization threshold for a duration which exceeds the threshold duration) to receive the processes executing on the client devices 502. The client devices 502, at step 610, may transmit, send, or otherwise provide the process and category lists of processes 514 executing on the client devices 502 to the resource manager 506. In some embodiments, the metrics analyzer service 516 may be configured to receive the processes from the TM service 503. For example, at step 610, the client devices 502 may be configured to transmit, send, or otherwise provide the list of processes 514 to the TM service 503 (e.g., responsive to the TM service 503 polling the client devices 502). The metrics analyzer service 516 may be configured to request the list of processes 514 of client devices 502 of the subset from the TM service 503. In some embodiments, the metrics analyzer service 516 may be configured to request the top N (e.g., 5, 10, 20, 50, etc.) processes executing on the client devices 502 from the subset.

As shown in FIG. 6, steps 602 and 610 may be performed in parallel, and at different intervals. For example, step 602 may be performed at a first time interval (e.g., every 5 minutes) and step 610 may be performed at a second time interval (e.g., every 10 minutes). However, in various embodiments, steps 602 and 610 may be performed together (e.g., the client devices 502 may be configured to provide the metrics on duration and processes together to the resource manager 506 and/or to the TM service 503 responsive to a poll, the resource manager 506 may be configured to retrieve or receive the metrics on duration and processes from the TM service 503 at the same interval or cadence, and so forth).

At step 612, the resource manager 506 may be configured to categorize processes executing on the client devices 502 of the subset. In some embodiments, the resource manager 506 may be configured to receive a category list from the client devices 502 (e.g., identifying different types or categories of processes executing on the respective client devices 502). At various instances, different client devices 502 of the subset may execute different processes which contribute to the corresponding client devices 502 having resource utilization which exceed the threshold resource utilization. The resource manager 506 may be configured to group together processes executing across all the client devices 502 of the subset into respective categories. The categories may include, for example, type of process (e.g., application, background process, OS process, enterprise process, virtualized process), sub-types for each type of process (e.g., type of application, type of background process, type of OS process, type of enterprise process, type of virtualized process), etc.

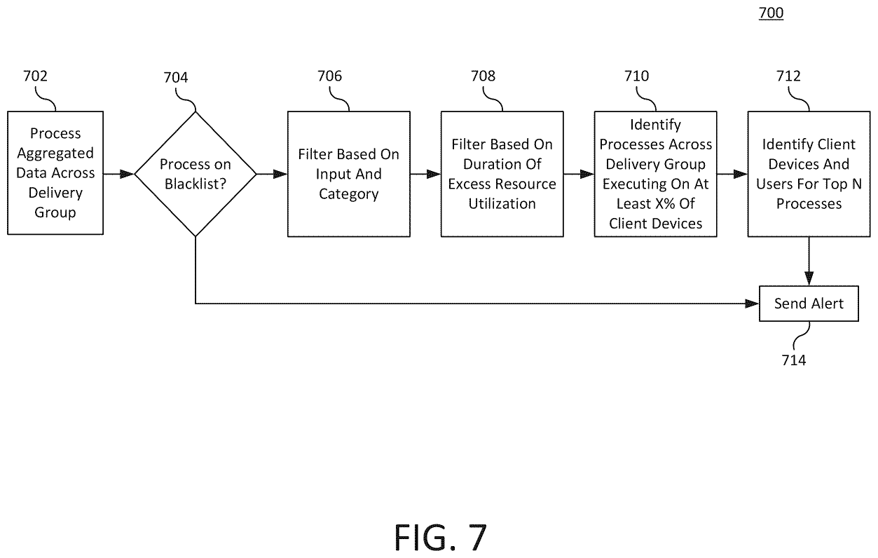

Referring now to FIG. 6 and FIG. 7, at step 700, the metrics analyzer service 516 may be configured to select processes across sites and delivery groups, and is described in greater detail with reference to FIG. 7. Specifically, FIG. 7 shows a process flow 700 of selecting processes across sites and delivery groups, according to an illustrative embodiment.

At step 702, the metrics analyzer service 516 may be configured to process the aggregated data (e.g., processes 514 and resource utilization metrics 512) across the client devices 502. In some embodiments, the metrics analyzer service 516 may be configured to compile the processes 514 (e.g., the top N processes 514) executing across the client devices 502. As noted above with reference to FIG. 5, the client devices 502 may be located across various geographic locations, and correspondingly access resources (e.g., as part of executing various processes 514) at different server/data center sites and via different delivery groups within the same server/data center. The metrics analyzer service 516 may be configured to compile the processes 514 across the data centers/cites and delivery groups.

At step 704, and as shown in FIG. 6, the policy service 518 may be configured to determine whether any of the processes 514 aggregated at step 702 are included in a blacklist defined or set by the administrator computing device 508. The administrator computing device 508 may be configured to set, define, or otherwise establish one or more policies corresponding to processes 514 executable on the client devices 502. The policies may include a blacklist of processes 514 (e.g., processes 514 which are to be excluded from execution), a whitelist of processes 514 (e.g., processes 514 which are required or otherwise permitted for execution), etc. The policies may be defined specifically for an enterprise (e.g., the policies may be specific to the enterprise). The blacklist of processes 514 may include, for example, known malware, expose vulnerabilities to enterprise resources, known processes 514 which consume excess resources, etc. In some embodiments, the blacklist of processes 514 may include categories or types of processes which are to be excluded, such as applications relating to explicit material, applications relating to social media, etc. The policy service 518 may be configured to cross-reference process names and/or process identifiers and the blacklist to determine whether any processes executing on the client device 502 is included in the blacklist. Where a process executing on a client device 502 is included in the blacklist, the resource manager 506 may be configured to generate and send an alert to the administrator computing device 508 as described in greater detail below. As such, the aggregated process data across the client devices 502 following step 704 may include permitted or allowed processes (e.g., processes which are not excluded from execution, or processes that are not included in the blacklist).

At step 706, the policy service 518 may be configured to filter the processes executing across the client devices 502 based on input and categories. As noted above, the policies defined by the administrator computing device 508 may also include a whitelist of processes 514. The whitelist of processes 514 may be or include known processes which are deemed acceptable, regardless of resource consumption. For instance, the whitelist of processes 514 may include applications which are used as part of day-to-day work by employees or members of the enterprise. As one example, an application for programming or generating computer aided design (CAD) drawings may consume significant resources, but may be included in the whitelist of processes by an admin based on there not being adequate alternatives to the application, based on the application being necessary to perform the user's tasks within the enterprise, etc. The whitelist of processes 514 may include a listing of acceptable processes, a listing of acceptable process types or categories, etc. The policy service 518 may be configured to filter processes executing across the client devices 502 by cross-referencing process names and/or process identifiers and names or identifiers from the whitelist. Where the policy service 518 identifies a process included in the whitelist, the policy service 518 may be configured to exclude or eliminate the process from the aggregated data.

At step 708, the metrics analyzer service 516 may be configured to filter processes from the aggregated data based on duration of excess resource utilization of the particular process. For example, the metrics analyzer service 516 may be configured to maintain, include, or otherwise access a threshold duration. The threshold duration may be the same as or similar to the threshold duration described above with reference to step 606. For instance, the metrics analyzer service 516 may be configured to determine the duration in which resource utilization 512 metrics for a particular process exceed a corresponding resource utilization threshold. The metrics analyzer service 516 may be configured to compare the duration to a threshold duration (e.g., exceeding for X number of minutes, such as one minute, two minutes, three minutes, four minutes, five minutes, etc.). The metrics analyzer service 516 may compare the duration to the threshold duration to eliminate temporary or intermittent spikes of processes 514 that cause increases in resource utilization 512.

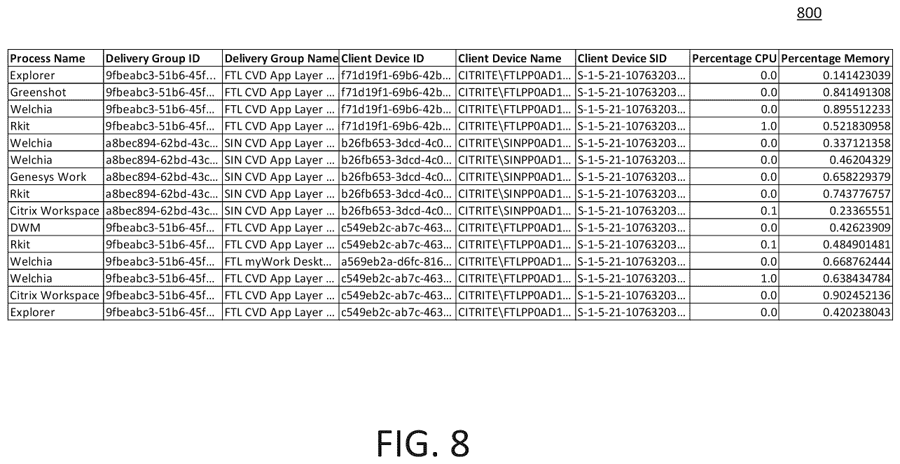

Following filtering at step 704-step 708, the metrics analyzer service 516 may compile the remaining aggregated data. For instance, FIG. 8 shows an example table 800 representing aggregated data from a plurality of client devices 502 following filtering. While shown as 15 rows of processes, it is noted that the remaining aggregated data may be orders of magnitude greater (e.g., 100+, 1000+, etc. rows of aggregated data) depending on the total number of client devices 502, number of processes executing on the client devices 502, etc. As such, FIG. 8 is simply for illustrative purposes. As shown in FIG. 8, the aggregated data may include process name of a process 514, delivery group identifier (e.g., an identifier of a delivery group at a particular site or data center), a delivery group name, a client device 502 identifier (ID), a client device 502 name, a client device 502 security identifier (SID), a percentage CPU usage of the process 514 relative to total CPU usage, a percentage memory utilized by the process 514, and so forth.

At step 710, the metrics analyzer service 516 may be configured to identify or select processes 514 across the delivery group (e.g., across all client devices 502) which are executing on a certain percentage of client devices 502. In some embodiments, the metrics analyzer service 516 may be configured to group, sort, or otherwise count the number of instances of each of the processes 514 included in the aggregated data across the delivery group. The metrics analyzer service 516 may be configured to compare the number of instances of each of the processes 514 to the total number of processes from the aggregated data. The metrics analyzer service 516 may be configured to identify or select processes having a total number of instances which satisfy a percentage threshold of the total number of processes. For example, the metrics analyzer service 516 may be configured to select processes having a total number of instances (e.g., of execution on different client devices 502) meeting or exceeding 10% of the total number of processes. In some embodiments, the metrics analyzer service 516 may be configured to store the data shown in the table 800 in one or more data structures 524 (e.g., step 614 of FIG. 6). The metrics analyzer service 516 may be configured to store the data for the selected processes in the data structure 524 for subsequent viewing and analysis (e.g., root cause analysis) by an admin using the administrator computing device 508.

At step 712, the device identification service 520 may be configured to identify, detect, or otherwise determine which of the client devices 502 are executing the processes selected at step 710. In some embodiments, the device identification service 520 may be configured to determine which of the client devices 502 are executing the processes 514 by performing a look-up using the process name (e.g., included in the aggregated data shown in FIG. 8) to identify client device ID, client device name, and/or client device SID which are executing the corresponding processes 514. The device identification service 520 may be configured to compile datasets of client device 502 and users of the client devices 502 for including in an alert or on a user interface to be rendered at the administrator computing device 508. For example, following identifying the client devices 502 executing the processes selected at step 710, the device identification service 520 may be configured to perform a look-up using the client device ID to identify the user of the client device 502. As another example, when the client devices 502 provide metrics on processes 514 and resource utilization 512 (e.g., to the resource manager 506 and/or to the TM service 503), the client devices 502 may be configured to provide a user identifier (e.g., user name, user log-in credentials, etc.). The device identification service 520 may be configured to identify the user of the client device 502 by identifying the user ID corresponding to the processes 514. The device identification server 520 may be configured to maintain or access a table or data structure that includes user ID associated with corresponding user names. The device identification server 520 may be configured to use the user ID corresponding to the processes 514 selected at step 710 to perform a look-up in the table/data structure to identify names of the corresponding users of the client devices 502.

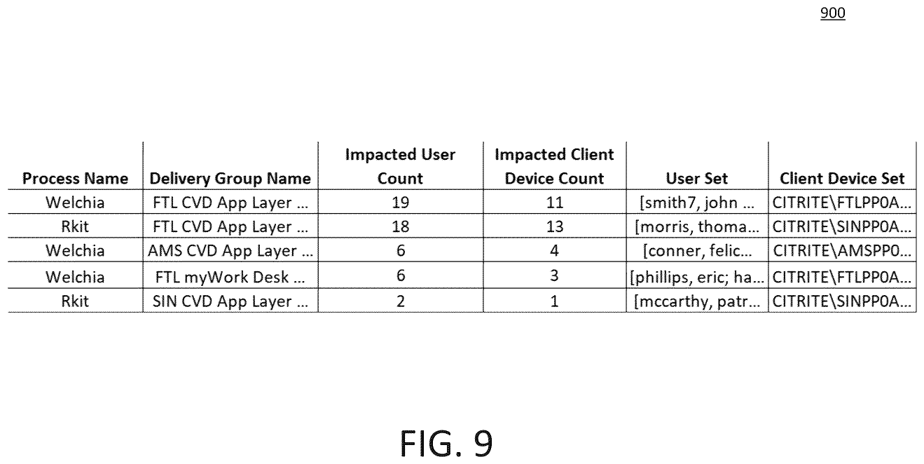

At step 714, the alert generation service 522 may be configured to produce, generate, or otherwise provide one or more alerts to the administrator computing device 508. In some embodiments, the alert generation service 522 may be configured to generate an alert which identifies the processes 514 selected at step 710 and client devices 502 identified at step 712. FIG. 9 shows an example table 900 showing data compiled by the alert generation service 522 that may be included in an alert provided to the administrator computing device 508. As shown in FIG. 9, and in some embodiments, the alert generation service 522 may be configured to compile data corresponding to the processes 514 selected at step 710, delivery groups of client devices 502 which are executing the processes 514, a count of number of impacted users (e.g., users operating client devices 502 executing the processes 514), a count of the client devices 502, a user set and client device set which identifies the users and the client devices 502.

The alert generation service 522 may be configured to push the alert to the administrator computing device 508. In some embodiments, the alert generation service 522 may be configured to push the alert to the administrator computing device 508 on-demand (e.g., responsive to a request received by the alert generation service 522 from the administrator computing device 508). In some embodiments, the alert generation service 522 may be configured to push the alert to the administrator computing device 508 at various predetermined intervals (e.g., hourly, daily, weekly, etc.). In some embodiments, the alert generation service 522 may be configured to push the alert to the administrator computing device 508 responsive to identifying new processes 514 contributing to excess resource utilization 512. The alert generation service 522 may trigger rendering of the alert on a user interface (e.g., step 616 of FIG. 6) at the administrator computing device 508 (e.g., on a webpage or portal displaying metrics and resource data across the delivery groups). For example, the user interface may be similar to the workspace environment management (WEM) service provided by Citrix Systems, Inc. of Fort Lauderdale, FL. Upon viewing the alert, an admin may take various actions including, for instance, triggering termination of the processes 514 on the respective client devices 502 (e.g., using a user interface element which, when selected, transmits a signal to the client devices 502 to cause the client devices 502 to terminate the corresponding processes 514 from execution), reevaluation of different processes 514 (e.g., determining whether alternative applications or resources may be used by users to perform the same or similar functions, etc.).

While described herein as being used to evaluate processes 514 contributing to excess resource utilization 512, it is noted that the systems and methods described herein may also be used for evaluating processes which may have security risks. For example, where processes 514 are included in one or more policies that are known to have security risks, those processes 514 may be identified from the aggregated data, and alerts may be generated in a manner similar to what is described above. Additionally, the systems and methods described herein may be used to evaluate monitor processes 514 over time during execution on client devices 502. For example, where a particular process 514 is executing normally (e.g., consuming an average amount of resources) for a period of time, then suddenly increasing resource utilization, the systems and methods described herein may track or monitor resource utilization over time of the process 514 along with other processes executing on the client device 502 to provide more insight on what may have contributed to the increase in resource utilization.

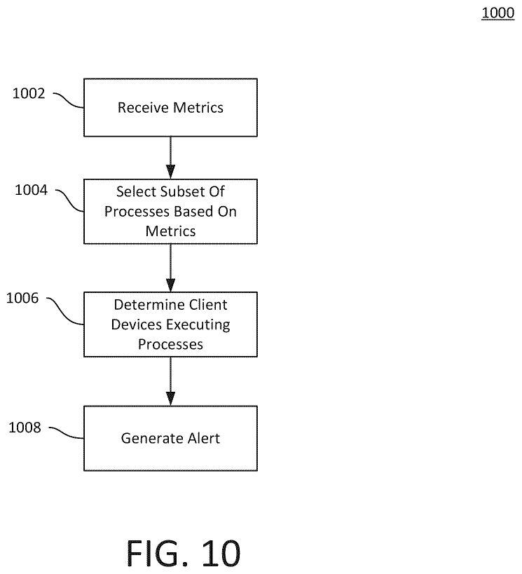

Referring now to FIG. 10, depicted is a flow diagram showing a method 1000 for analyzing process and resource metrics across client devices, in accordance with an illustrative embodiment. The method 1000 may be performed by the devices/components/elements described above with reference to FIG. 1A-FIG. 5. As a brief overview, at step 1002, a resource manager may receive metrics. At step 1004, the resource manager may select a subset of processes based on the metrics. At step 1006, the resource manager may determine client devices executing the processes. At step 1008, the resource manager may generate an alert.

In further detail, at step 1002, a resource manager may receive metrics. In some embodiments, the resource manager may receive metrics on resource utilization of a plurality of processes executing on at least some of a plurality of client devices. The metrics may include, for example, a duration in which each of the client devices have resources which exceed a threshold and a list of processes executing on the client devices for the duration. The client devices may include a task manager service which monitors for resource utilization and processes executing on the client device. The resource manager may receive the metrics from a traffic management service to which the client devices provided the metrics. Additionally or alternatively, the resource manager may receive the metrics directly from the client devices (e.g., bypassing the traffic management service).

In some embodiments, the resource manager may poll the client devices and/or traffic management service for the metrics at various intervals. For example, the resource manager may poll the client devices and/or traffic management service every five minutes, every ten minutes, etc. In some embodiments, the resource manager may poll the client devices and/or traffic management service at different intervals for different metrics. For example, the resource manager may poll the client devices and/or traffic management service every five minutes for metrics on resource utilization (e.g., duration in which resource utilization satisfies, meets, and/or exceeds a threshold), and every ten minutes for metrics on processes executing on the client devices (e.g., for or during the duration). While described as polling, it is noted that, in some embodiments, the client devices and/or traffic management service may publish or push the metrics to the resource manager at various intervals (e.g., rather than the resource manager polling and the client devices and/or traffic management service responding to the poll with the metrics).

In some embodiments, the resource manager may categorize each of the plurality of processes into respective process categories. The resource manager may receive, retrieve, maintain, or otherwise access various categories in which processes received (e.g., at step 1002) may be categorized. The resource manager may categorize the processes into the various categories according to process type (e.g., application, background process, OS process, enterprise process, virtualized process), sub-types for each type of process (e.g., type of application, type of background process, type of OS process, type of enterprise process, type of virtualized process), etc. The resource manager may categorize the processes using process names, process identifiers, etc. received in the metrics from the client devices (e.g., directly or indirectly through the traffic management service). The resource manager may categorize the processes on a rolling basis (e.g., as the metrics are received from the client devices and/or traffic management service). As such, processes executing across all client devices may be categorized together into respective categories by the resource manager.

In some embodiments, the resource manager may apply a filter to the plurality of processes based on a policy corresponding to at least some of the plurality of processes. The resource manager may receive the policy from an administrator computing device. The policy may include or identify processes which are to be excluded from execution (e.g., processes which are black listed or on a blacklist). The policy may include or identify processes which are to be permitted to execute (e.g., regardless of resource utilization, or processes which are white listed or on a whitelist). The resource manager may apply the policy to the processes received at step 1002 to determine whether any processes match or satisfy one or more of the policies (e.g., identify processes included in the blacklist and/or processes included in the whitelist). In some embodiments, the resource manager may exclude, remove, or otherwise filter a process from the plurality of processes based on the process being included in the whitelist responsive to applying the policy to the list of processes. In some embodiments, the resource manager may generate an alert (e.g. separate alert from the alert generated at step 1008) responsive to a process being included in the blacklist responsive to applying the policy to the list of processes, as described in greater detail below.

In some embodiments, the resource manager may filter a first process from one or more processes (executing on a respective client device) based on a duration in which the first process executed on the respective client device. For example, the resource manager may determine (e.g., using the metrics received at step 1002) a duration in which the first process executed on the client device. The resource manager may compare the duration to a threshold. The resource manager may filter the process based on the duration satisfying the threshold (e.g., being less than or equal to the threshold). The resource manager may filter the process to eliminate intermittent processes that may consume or contribute to excess resource utilization but over a short or minor duration.

At step 1004, the resource manager may select a subset of processes based on the metrics. In some embodiments, the resource manager may select a subset of the plurality of processes based on the metrics. The resource manager may select the subset responsive to filtering the processes as described above. In some embodiments, the resource manager may select the subset of processes based on the metrics and a number of the plurality of client devices which are executing the subset of the plurality of processes. For example, the resource manager may count a number of instances in which the same process is executing on different client devices. The resource manager may compare the number of instances to a total number of processes executing across the plurality of client devices. The resource manager may select a subset of processes based on a proportion of the number of instances of a given process relative to the total number of processes. For example, the resource manager may select a particular process responsive to the process executing on a certain percentage of client devices (e.g., greater than or equal to 5%, 10%, etc.).

At step 1006, the resource manager may determine client devices executing the processes. In some embodiments, the resource manager may determine a subset of the plurality of client devices which are executing the selected subset of processes. In some embodiments, the resource manager may cross-reference the selected processes (e.g., at step 1004) with the metrics received at step 1002 to identify which client devices are executing the selected subset of processes. For instance, the metrics may include client device identifier(s) which identify the particular client device which provided the corresponding metrics. The resource manager may perform a look-up using the selected processes (e.g., a process name) to identify which client devices are executing the selected processes.

At step 1008, the resource manager may generate an alert. In some embodiments, the resource manager may generate an alert which identifies the subset of processes and the subset of client devices which are executing the subset of processes. In some embodiments, the resource manager may generate the alert for transmission to the administrator computing device. The resource manager may transmit the alert to the administrator computing device responsive to generating the alert. In some embodiments, the alert may be a list of the processes (e.g., selected at step 1004) and the identified client devices (e.g., determined at step 1006). The alert may be a notification rendered on the administrator computing device which, when open, causes the administrator computing device to access a user interface which includes the alert and the identified information/data (e.g., selected processes and determined client devices).

In some embodiments, the resource manager may identify, from the plurality of processes, at least one process to be excluded from execution. For example, the resource manager may identify the at least one process responsive to applying one or more of the policies described above with reference to step 1002. The at least one policy may, for instance, be included in a blacklist of processes which are to be excluded from execution on client devices. The resource manager may determine which of the plurality of client devices are executing the at least one process. The resource manager may determine which client device(s) are executing the at least one process in a manner similar to the determination made at step 1006. The resource manager may generate a second alert identifying the at least one process and which of the plurality of client devices are executing the at least one process.

In some embodiments, the resource manager may store the identified subset of processes and the subset of client devices which are executing the subset of processes in one or more data structures. The data structures may be or include a database which is accessible by the administrator computing device. In some embodiments, when the alert is transmitted to the administrator computing device, the administrator computing device may launch a user interface which pulls, retrieves, or otherwise displays data from the database (e.g., including the identified subset of processes and client devices). An administrator using the administrator computing device may view the data/information, perform root cause analysis (RCA), and may take various actions based on the data (e.g., kill or terminate one or more processes from execution, identify alternative or different processes that may not consume as significant resources, schedule a user of a particular client device for a client device upgrade or servicing to increase available resources, etc.).

Various elements, which are described herein in the context of one or more embodiments, may be provided separately or in any suitable subcombination. For example, the processes described herein may be implemented in hardware, software, or a combination thereof. Further, the processes described herein are not limited to the specific embodiments described. For example, the processes described herein are not limited to the specific processing order described herein and, rather, process blocks may be re-ordered, combined, removed, or performed in parallel or in serial, as necessary, to achieve the results set forth herein.

It should be understood that the systems described above may provide multiple ones of any or each of those components and these components may be provided on either a standalone machine or, in some embodiments, on multiple machines in a distributed system. The systems and methods described above may be implemented as a method, apparatus or article of manufacture using programming and/or engineering techniques to produce software, firmware, hardware, or any combination thereof. In addition, the systems and methods described above may be provided as one or more computer-readable programs embodied on or in one or more articles of manufacture. The term “article of manufacture” as used herein is intended to encompass code or logic accessible from and embedded in one or more computer-readable devices, firmware, programmable logic, memory devices (e.g., EEPROMs, ROMs, PROMs, RAMs, SRAMs, etc.), hardware (e.g., integrated circuit chip, Field Programmable Gate Array (FPGA), Application Specific Integrated Circuit (ASIC), etc.), electronic devices, a computer readable non-volatile storage unit (e.g., CD-ROM, USB Flash memory, hard disk drive, etc.). The article of manufacture may be accessible from a file server providing access to the computer-readable programs via a network transmission line, wireless transmission media, signals propagating through space, radio waves, infrared signals, etc. The article of manufacture may be a flash memory card or a magnetic tape. The article of manufacture includes hardware logic as well as software or programmable code embedded in a computer readable medium that is executed by a processor. In general, the computer-readable programs may be implemented in any programming language, such as LISP, PERL, C, C++, C#, PROLOG, or in any byte code language such as JAVA. The software programs may be stored on or in one or more articles of manufacture as object code.

While various embodiments of the methods and systems have been described, these embodiments are illustrative and in no way limit the scope of the described methods or systems. Those having skill in the relevant art can effect changes to form and details of the described methods and systems without departing from the broadest scope of the described methods and systems. Thus, the scope of the methods and systems described herein should not be limited by any of the illustrative embodiments and should be defined in accordance with the accompanying claims and their equivalents.

It will be further understood that various changes in the details, materials, and arrangements of the parts that have been described and illustrated herein may be made by those skilled in the art without departing from the scope of the following claims.

We claim:

1. A method, comprising:
receiving, by one or more processors, metrics on resource utilization of a plurality of processes executing on at least some of a plurality of client devices;
selecting, by the one or more processors, a subset of the plurality of processes based on the metrics;
determining, by the one or more processors, a subset of the plurality of client devices which are executing the selected subset of processes; and
generating, by the one or more processors, an alert which identifies the subset of processes and the subset of client devices which are executing the subset of processes.

2. The method of claim 1, further comprising:
applying, by the one or more processors, a filter to the plurality of processes based on a policy corresponding to at least some of the plurality of processes.

3. The method of claim 1, wherein the alert is a first alert, the method further comprising:
identifying, by the one or more processors, from the plurality of processes, at least one process to be excluded from execution;
determining, by the one or more processors, which of the plurality of client devices are executing the at least one process; and
generating, by the one or more processors, a second alert identifying the at least one process and which of the plurality of client devices are executing the at least one process.

4. The method of claim 1, wherein the metrics comprise, for each of the plurality of client devices:
a duration in which a respective client device has resources exceeding a threshold; and
a list of processes executing on the client device for the duration.

5. The method of claim 4, wherein the duration is received at a first time interval, and the list of processes is received at a second time interval.

6. The method of claim 1, further comprising categorizing, by the one or more processors, each of the plurality of processes into respective process categories.

7. The method of claim 1, further comprising filtering, by the one or more processors, from one or more processes executing on a respective client device, a first process from the one or more processes based on a duration in which the first process executed on the respective client device.

8. The method of claim 1, wherein selecting the subset of the plurality of processes is based on the metrics and a number of the plurality of client devices which are executing the subset of the plurality of processes.

9. The method of claim 8, wherein a process of the plurality of processes is selected based on a proportion of the number of the plurality of client devices which are executing the process relative to a total number of the plurality of clients.

10. The method of claim 1, further comprising storing, by the one or more processors, in one or more data structures, the identified subset of processes and the subset of client devices which are executing the subset of processes.

11. A system, comprising:
one or more processors configured to:
receive metrics on resource utilization of a plurality of processes executing on at least some of a plurality of client devices;
select a subset of the plurality of processes based on the metrics;
determine a subset of the plurality of client devices which are executing the selected subset of processes; and
generate an alert which identifies the subset of processes and the subset of client devices which are executing the subset of processes.

12. The system of claim 11, wherein the one or more processors are configured to apply a filter to the plurality of processes based on a policy corresponding to at least some of the plurality of processes.

13. The system of claim 11, wherein the alert is a first alert, and wherein the one or more processors are further configured to:
identify, from the plurality of processes, at least one process to be excluded from execution;
determine which of the plurality of client devices are executing the at least one process; and
generate a second alert identifying the at least one process and which of the plurality of client devices are executing the at least one process.

14. The system of claim 11, wherein the metrics comprise, for each of the plurality of client devices:
a duration in which a respective client device has resources exceeding a threshold; and
a list of processes executing on the client device for the duration.

15. The system of claim 11, wherein the one or more processors are further configured to categorize each of the plurality of processes into respective process categories.

16. The system of claim 11, wherein the one or more processors are further configured to filter, from one or more processes executing on a respective client device, a first process from the one or more processes based on a duration in which the first process executed on the respective client device.

17. The system of claim 11, wherein the one or more processors are configured to select the subset of the plurality of processes based on the metrics and a number of the plurality of client devices which are executing the subset of the plurality of processes.

18. The method of claim 17, wherein a process of the plurality of processes is selected based on a proportion of the number of the plurality of client devices which are executing the process relative to a total number of the plurality of clients.

19. The system of claim 11, wherein the one or more processors are further configured to store, in one or more data structures, the identified subset of processes and the subset of client devices which are executing the subset of processes.

20. A non-transitory computer readable medium storing instructions that, when executed by one or more processors, cause the one or more processors to:
receive metrics on resource utilization of a plurality of processes executing on at least some of a plurality of client devices;
select a subset of the plurality of processes based on the metrics;
determine a subset of the plurality of client devices which are executing the selected subset of processes; and
generate an alert which identifies the subset of processes and the subset of client devices which are executing the subset of processes.
